(19) United States
(12) Patent Application Publication
(10) Pub. No.: US 2004/0200101 A1
(43) Pub. Date: Oct. 14, 2004

(54) Picture frame

(76) Inventor: Su-Chin Lai, Taichung (TW)

Correspondence Address: Su-Chin Lai, 58, MA YUAN WEST ST., TAICHUNG, TW

(21) Appl. No.: 10/412,356

(22) Filed: Apr. 9, 2003

(51) Int. Cl. G09F 19/14

(52) U.S. Cl. 40/453

(57) ABSTRACT

A picture frame has a photograph, a transparent plate having a corrugation portion, a plurality of pictorial stripes disposed on a back of the transparent plate, a front frame, and a rear plate. The photograph is disposed on the rear plate. The transparent plate is disposed on the photograph. The front frame is disposed on the transparent plate.

### BACKGROUND OF THE INVENTION

The present invention relates to a picture frame. More particularly, the present invention relates to a picture frame which has a transparent plate having a corrugation portion.

A conventional picture frame often contains a single picture or photograph only. However, it is difficult to add patterns and change patterns on the picture or photograph.

### SUMMARY OF THE INVENTION

An object of the present invention is to provide a picture frame which has a photograph, a transparent plate having a corrugation portion, and a plurality of pictorial stripes disposed on the transplate plate to show different pictures from different angles.

Accordingly, a picture frame comprises a photograph, a transparent plate having a corrugation portion, a plurality of pictorial stripes disposed on a back of the transparent plate, a front frame, and a rear plate. The photograph is disposed on the rea r plate. The transparent plate is disposed on the photograph. The front frame is disposed on the transparent plate.

### BRIEF DESCRIPTION OF THE DRAWINGS

FIG. 1 is a perspective exploded view of a plurality of pictorial stripes and a transparent plate of a preferred embodiment in accordance with the present invention;

FIG. 2 is a perspective exploded view of a picture frame of a preferred embodiment in accordance with the present invention;

FIG. 3 is a front elevational assembly view of a picture frame of a preferred embodiment in accordance with the present invention;

FIG. 4 is a sectional assembly view of a picture frame of a preferred embodiment in accordance with the present invention;

FIG. 5 is a schematic view illustrating a first application of a picture frame of a preferred embodiment in accordance with the present invention; and

FIG. 6 is a schematic view illustrating a second application of a picture frame of a preferred embodiment in accordance with the present invention.

### DETAILED DESCRIPTION OF THE INVENTION

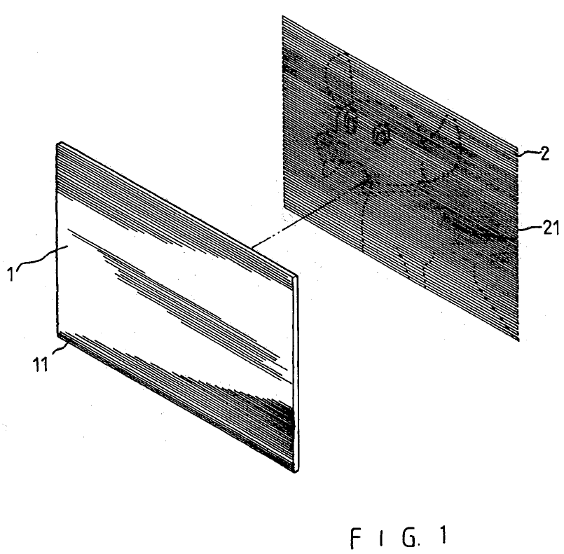

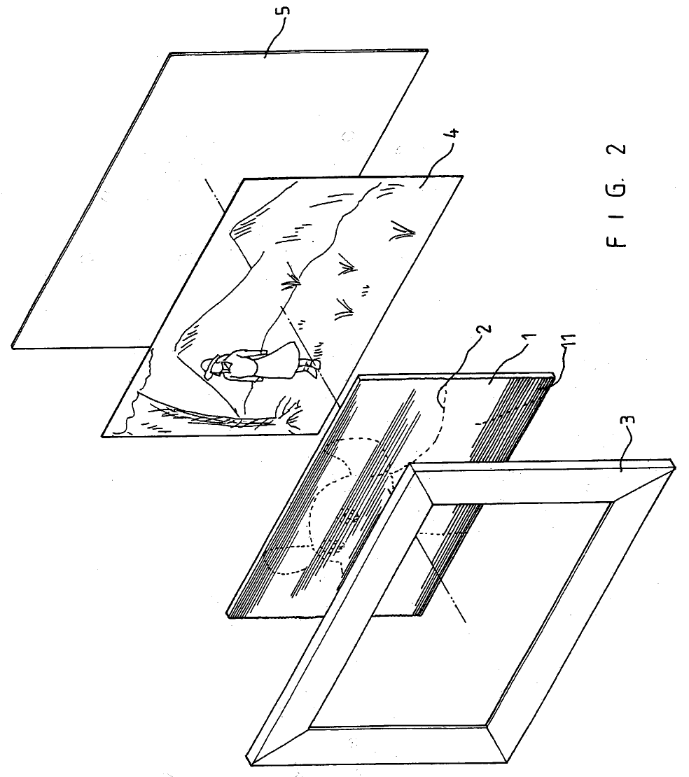

Referring to FIGS. 1 to 6, a picture frame comprises a photograph 4, a transparent plate 1 having a corrugation portion 11, a plurality of pictorial stripes 2 disposed on a back of the transparent plate 1, a front frame 3, and a rear plate 5.

The photograph 4 is disposed on the rear plate 5.

The transparent plate 1 is disposed on the photograph 4.

The front frame 3 is disposed on the transparent plate 1.

A plurality of spacings 21 are defined among the pictorial stripes 2.

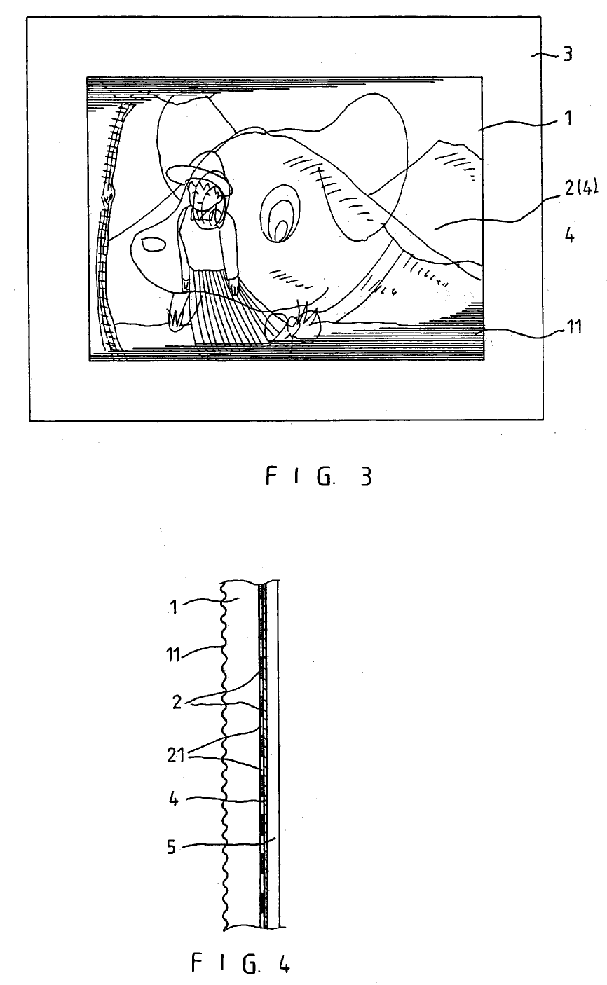

Referring to FIG. 3 again, a picture on the pictorial stripes 2 and the photograph 4 are overlapped.

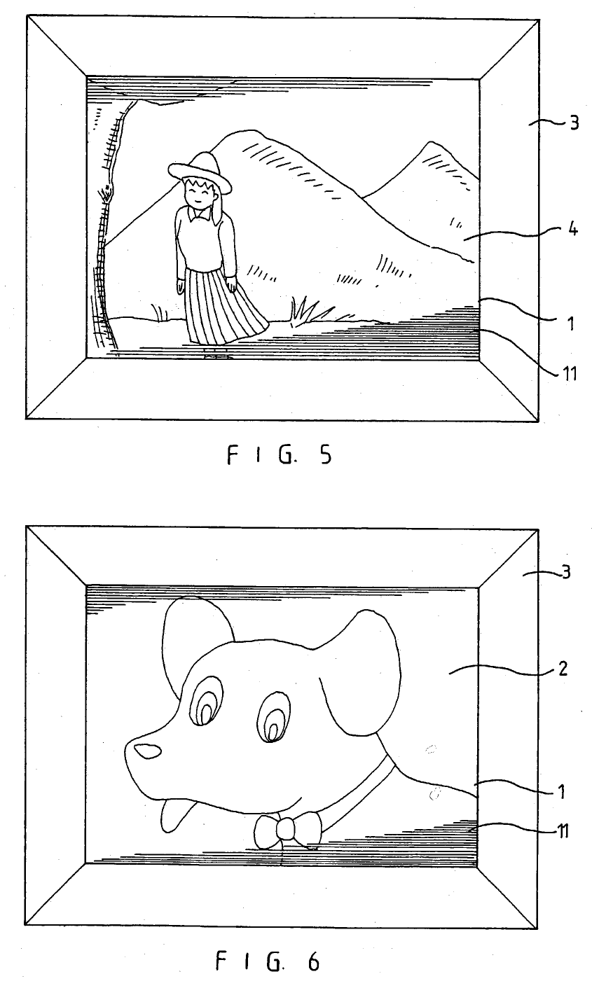

Referring to FIG. 5 again, a normal front view of the picture frame shows a picture on the photograph 4 only. Because a refraction of the corrugation portion 11 of the transparent plate 1, the picture on the pictorial stripes 2 is hidden.

Referring to FIG. 6 again, a higher front view of the picture frame shows the picture on the pictorial stripes 2 only. Because a refraction of the corrugation portion 11 of the transparent plate 1, the picture on the photograph 4 is hidden.

The invention is not limited to the above embodiment but various modification thereof may be made. Further, various changes in form and detail may be made without departing from the scope of the invention.

I claim:

1. A picture frame comprises:
a photograph, a transparent plate having a corrugation portion, a plurality of pictorial stripes disposed on a back of the transparent plate, a front frame, and a rear plate,
the photograph disposed on the rear plate,
the transparent plate disposed on the photograph, and
the front frame disposed on the transparent plate.

2. The picture frame as claimed in claim 1, wherein a plurality of spacings are defined among the pictorial stripes.
